(19) United States
(12) Patent Application Publication
(10) Pub. No.: US 2007/0007120 A1
(43) Pub. Date: Jan. 11, 2007

(54) Desalinator

(76) Inventor: William P. Taylor, Laguna Hills, CA (US)

Correspondence Address: STOUT, UXA, BUYAN & MULLINS LLP, 4 VENTURE, SUITE 300, IRVINE, CA, 92618, US

(21) Appl. No.: 11/177,982

(22) Filed: Jul. 11, 2005

(51) Int. Cl. B01D 3/42; C02F 1/04

(52) U.S. Cl. 203/1; 203/10; 203/49; 202/185.3

(57) ABSTRACT

A desalinator is disclosed wherein the energy required for evaporation is provided primarily by the energy released during condensation in a counterflow heat exchanger consisting of an outer chamber and an inner tube or tubes. Sea water is evaporated into air at ambient pressure in the inner tube; this air-vapor mixture is then heated and reintroduced into the outer chamber where it heats the contents in the inner tube as it cools and its vapor condenses to distilled water.

The background of the invention is discussed in two parts.

### BACKGROUND

1. Field of the Invention

The present invention relates generally to fresh water extraction apparatus and methods, and more particularly to improved desalination apparatus amenable to being powered by a gas (or other fossil fuel) fired heater, gethermal, solar, or electric energy.

2. Description of the Related Art

Although the apparatus of the invention will herein be referred to as a “desalinator”, such term is understood to include apparatus for removal of salts and other contaminants from saltwater, and “saltwater” is understood to include any fluid substance containing water, such as saltwater, brine, waste water, or other impurities or contaminants. A number of technologies have been developed for desalination, including reverse osmosis, distillation, electrodialysis, and vacuum freezing.

A typical problem associated with desalination apparatus is that the cost of desalination is generally higher than the cost of other water supply alternatives; consequently, desalination plant installations are not numerous. However, as supplies continue to lag demand for fresh water, desalination projects will be increasingly attractive; there is, therefore, a growing need for inexpensive desalination apparatus of low operating cost.

### SUMMARY

The present invention produces distilled water from sea water with low energy input by supplying most of the heat required for evaporation with the heat released during condensation. Sea water and ambient air enter the inner tube of a counterflow heat exchanger (CFHX) where the combination is heated and the sea water partially evaporated; the resultant hot humidified air then exhausts to a heater where its temperature is increased before reentering the outer chamber of the CFHX and cooled, condensing its moisture, by transferring heat to the inner tube. The resultant product drains as cool distilled water and the unevaporated sea water, now brine, drains after cooling to near ambient temperature.

### DRAWINGS

FIG. 1 is a cross-section view of a basic desalinator showing the essential components of the invention.

FIG. 2 is a cross-section view of the inner tube of FIG. 1 showing the two passages, the upper where sea water evaporates and the lower, containing brine.

FIG. 3 is a partially cut-away view of a practical size desalinator incorporating a cluster of inner tubes, the cluster contained within a single outer enclosure;

FIG. 4 is a partially cut-away view of the cool end chamber of FIG. 3 illustrating water entrance.

FIG. 5 depicts a technique for obtaining the desired ratio of sea water to product in the apparatus of FIG. 3.

FIG. 6 is a partially cut-away view of the cool end chamber of the apparatus of FIG. 3 illustrating level control technique and brine flow parameters.

### DESCRIPTION

The present invention is a desalination apparatus that produces distilled water from sea water with low thermal energy input by providing most of the heat required for evaporation with the heat released during condensation. Sea water and ambient air enter an inner tube of a longitudinal counterflow heat exchanger (CFHX) where they are heated and the sea water partially evaporated. The hot humid air exhausts to a heater where its temperature is increased before re-entering the CFHX in the outer chamber where it transfers heat to the inner tube as it cools and its vapor condensed. The condensed moisture exits as distilled water product and the unevaporated sea water drains as brine. The heater elevates the temperature of the air-vapor mixture sufficiently to permit heat transfer from the outer chamber to the inner tube. A fan provides air circulation and the water circulates by gravity. A thermal gradient exists in the CFHX with the air and sea water entering at the cool end at near ambient temperature and the opposite end hot. The evaporation process is the same as occurs in nature where moisture from oceans, lakes, etc. enters the atmosphere as vapor whenever the air temperature exceeds that of the water. Similarly the condensation process duplicates nature, where condensation occurs whenever vapor laden air cools to the dew point.

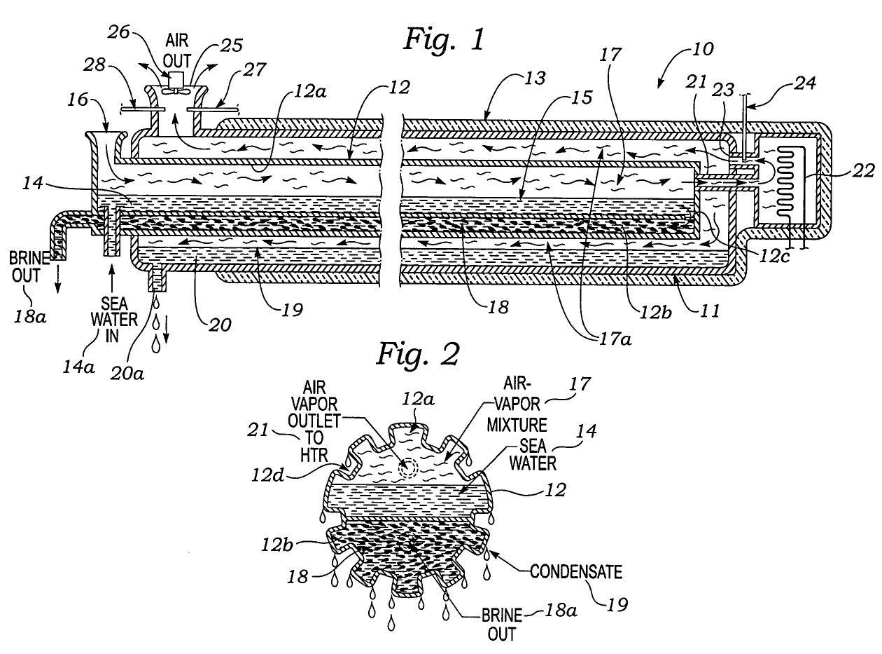

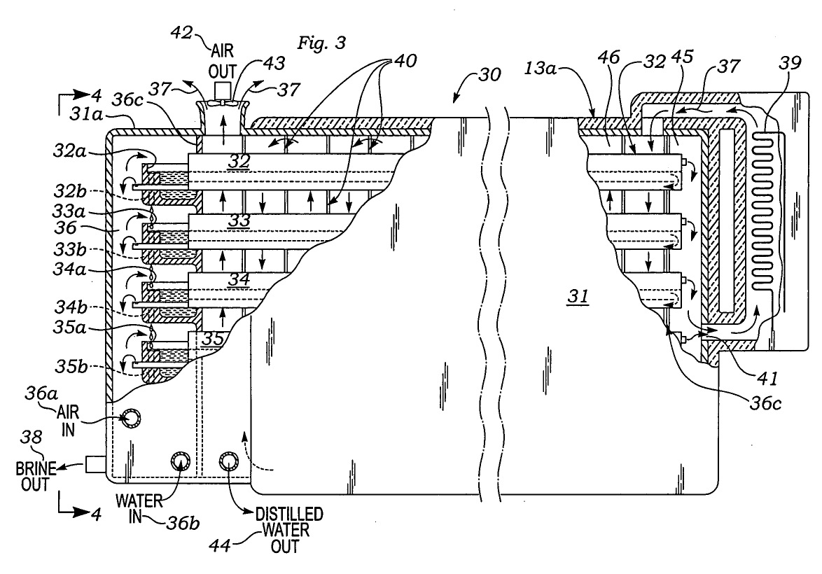

Refer now to the drawings, where like reference numerals refer to like elements in the several views. FIGS. 1 and 2 illustrate the essential elements of the present invention. Generally designated 10, the desalination apparatus comprises an outer chamber 11 encompassing an inner chamber, or tube 12 wherein inner tube 12 includes two passages; an upper passage 12a and a lower passage 12b. In upper passage 12a ambient air 16 and sea water 14 enter and the sea water is partly evaporated. The resultant air-vapor mixture 17 exhausts through the air-vapor outlet 21 into the heater 22 where the temperature increases. The air-vapor mixture 17 is then pulled by the circulating fan 26 through the heater 22 into outer chamber of the CFHX 11 where the air-vapor mixture 17 transfers heat to the inner tube. The inner tube corrugations 12d increase the heat transfer area thereby increasing the rate of condensation.

Sea water 14 which remains after the evaporation step (approximately half the quantity entering), now brine 18, flows through connecting opening 12c at the hot end of upper passage 12a into the lower passage 12b where it flows, releasing heat in a secondary counterflow heat exchanger, to the cool end. Brine 18 is evacuated from the apparatus through brine outlet 18a. Fan 26 circulates the air-vapor mixture through the CFHX and out through air outlet 25. The sea water 14 and brine 18 circulate by gravity.

Practical Size Desalinator

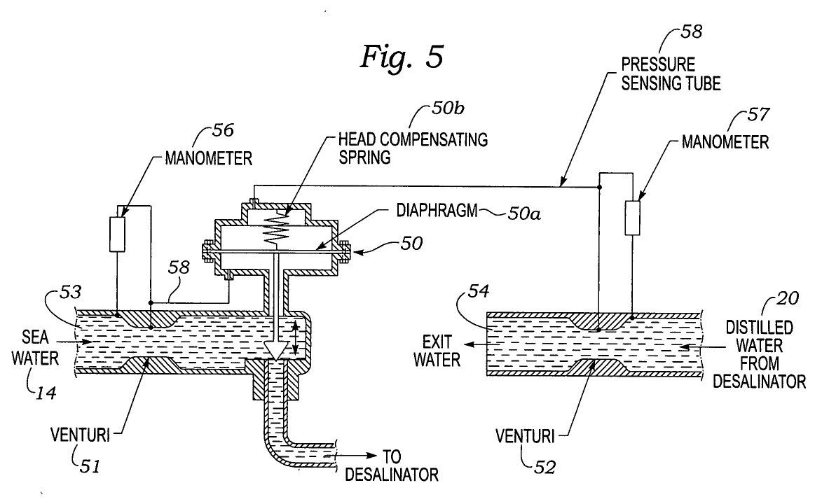

FIG. 3 is a partially cut-away view illustrating a practical size desalinator, generally indicated 30, that is comprised of a single insulated housing 31 enclosing a cluster of inner tubes 32-35 substantially identical to inner tube 12 as depicted in FIGS. 1 and 2 and previously described. Ambient air and sea water enter chamber 36 of the housing 31 through air inlet 36a and sea water inlet 36b respectively, and thence flow into the inner tubes 32-35 with brine draining from this chamber 36 at brine outlet 38. Barrier 36c maintains the integrity of chamber 36 to avoid mixing of the entering air with the exhausting air. As indicated, baffles 40 with openings (not shown) alternating at top and bottom direct the air-vapor mixture 17, as shown by arrows 37, across the tubes 32-35 in multiple passes as it traverses the desalinator 30 from the hot end to the air exhaust 42 at the cool end. Air-vapor mixture 17 is pulled by circulating fan 43 through the air inlet 41, through the upper passages 12a, the heater 39, and past the baffles 40 to the cool end and the air exhaust 42. The distilled water product exits at the cool end at outlet 44. Monitoring of performance may be by means of thermocouples such as 24 and 27 with air flow rates monitored by pitot tube 28, and water rates by venturis (shown in FIG. 5).

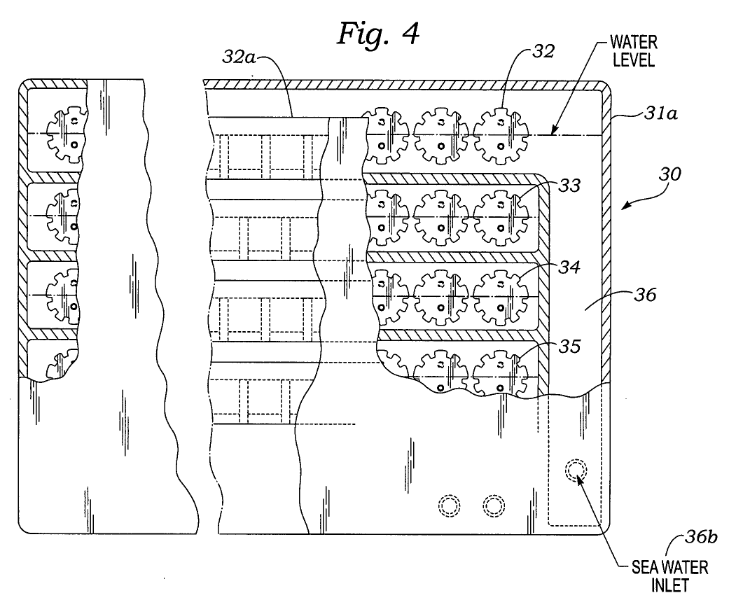

Sea water 14 enters chamber 36 through inlet 36b which communicates via a passage (shown in FIG. 4) with the upper trough 32a of inner tube 31a. Trough 32a fills until holes 32b are reached whereupon the sea water drains to the next lower trough 33a and so on until all troughs 32a-35a are filled to the proper level with a small excess flow of sea water which mixes with the brine and drains at brine outlet 38.

FIG. 4 is a partially cut-away view of the desalinator brine chamber 36 as indicated by lines 4-4 of FIG. 3. As previously explained, sea water 14 enters the desalinator 30 via a passage which communicates with an upper trough 32a where the openings of the top row of tubes 32-35 are exposed.

FIG. 5 depicts a technique for obtaining a small excess sea water input used for level control. In this technique the flow rate of sea water 14 is controlled to 2.2 times that of product, providing the desired ratio of sea water to brine of 2.1 in tubes 32-35 with an excess overflowing to the bottom of the brine chamber 36. A diaphragm-operated throttling valve 50 controls the flow rate of sea water in response to signals obtained from the venturis 51, 52 located in the sea water inlet passage 53 and the product outlet 54 repectively. The venturis are sized such that the flow ratio is correct when the throat pressures, as sensed by pressure sensing tube 58, are equal (except for the higher head of the sea water for which a head spring 50b compensates). In coordination with pressure sensing tube 58 the manometers 56, 57 permit measuring the two flow rates for performance monitoring. Performance may be monitored by measuring the flow rates of the circulating air, the sea water and the distilled water product; and the temperature leaving the heater and air exhaust.

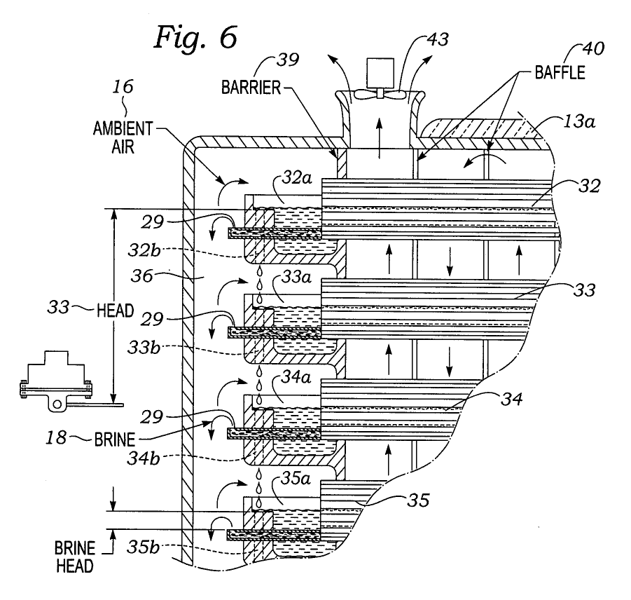

FIG. 6 is a partially cut-away view of the cool exit end of the apparatus of FIG. 3 illustrating brine flow control. The brine flow rate is determined by the aperture size 29 in the brine tube outlet and the head 30 indicated. The head 33 with which the valve spring 50b compensates is also shown.

Performance can be enhanced by recirculation of the air; accomplished schematically by connecting the air exhaust 25 to the air intake 16. To modify FIG. 3 for recirculation, the fan is relocated to the barrier 36c, exhausting to chamber 36. In a recirculating system the brine chamber should be vented to ambient to prevent pressure buildup in the desalinator by dissolved gases in the sea water, which are released during heating. A recirculating system permits use of a carrier gas other than air.

Performance

Performance is calculated under the following conditions, neglecting the small amount of energy needed to drive the fan and any energy needed to pump a sea water supply.
Ambient: 70 degrees F., sea level
Entering air: 70 degrees F.; vapor content of 0.0158 lb. per lb. of dry air; enthalpy of 26.34 Btu per lb. of dry air
Temperature entering heater: 190 degrees F.; vapor content: 1.062 lb. per lb. of dry air
Exhaust air: 72 degrees F.; vapor content of 0.0169 lb. per lb. of dry air; enthalpy of 28.1 Btu per lb. of dry air
Entering sea water: 70 degrees F.; enthalpy of 36.1 Btu per lb
Exiting product: 72 degrees F.; enthalpy of 40 Btu per lb
Exiting brine: 72 degrees F.; enthalpy of 38 Btu per lb
Product produced: 1.062-0.0169=1.045 lb. per lb. of dry air
Sea water evaporated: 1.062-0.0158=1.046 lb. per lb. of dry air (this also is brine quantity)
Energy entering desalinator: Q+2.092 (36.1)+26.34 Btu per lb. of dry air
Energy exiting desalinator: 1.045(40)+1.046(38)+28.1 Btu per lb. of dry air
Heat required=Q=7.79 Btu per lb. of dry air; 7.45 Btu per lb. of product (202.5 therms per acre-ft).

As mentioned above, performance can be enhanced by recirculation of the air. With this change, and again neglecting the small amount of energy to drive the fan and pump, and using the same temperatures as above for sea water, product and brine, performance is as follows:
Heat required: 6.03 Btu per lb of dry air, 5.77 Btu per lb of product (156.9 therms per acre-ft).

Advantages of the present invention include the following:
(1) The energy required for operation is thermal, inherently less expensive than electrical or mechanical.
(2) The unit operates at ambient pressure, inside and out. There is no high pressure pump as required for reverse osmosis, nor vacuum as required for multi-stage distillation,
(3) Hardware simplicity. No delicate membranes.
(4) Low fouling potential since the brine is returned to the environment at salt levels minimizing precipitation.
(5) Inexpensive construction. Plastic can be used extensively; however the inner tubes are aluminum because of its superior thermal conductivity.
(6) A pure distilled water product is produced, there being no carry over of sea water as occurs in processes where the water is boiled, nor the less-than-perfect desalination of reverse osmosis.
(7) Light weight. The desalinator can be made as a portable unit to permit emergency use when a disaster has compromised the normal source of potable water.
(8) Adaptable for use in third world countries without an electrical grid; the fan and pump electrical requirements can be met with solar cells and batteries, and bottled propane can supply thermal energy.
(9) Low maintenance. No delicate, easily fouled membranes typical of reverse osmosis systems.
(10) Durable. Its cost can be amortized over many years.
(11) Environmentally friendly. Noiseless, odorless, and the brine exhaust is at near ambient temperature with salt content less than double that of sea water.

The invention has been described by way of example, however, it is to be understood that various adaptations and modifications may be made within the scope of the invention.

What is claimed is

1. (canceled)

2. (canceled)

3. (canceled)

4. (canceled)

5. (canceled)

6. (canceled)

7. (canceled)

8. (canceled)

9. Desalination apparatus for extracting fresh water from impure water comprising:
a longitudinally extending counter-flow heat exchanger including a thermally insulated longitudinally extending outer chamber substantially encompassing a longitudinally extending inner chamber, said heat exchanger having a cool end and a hot end;
said inner chamber composed of a thermally conductive material and including an upper passage and a lower passage, said upper passage and said lower passage cooperating to form a secondary counter-flow heat exchanger;
said upper passage including an ambient air inlet and an impure water inlet proximate said cool end to produce an air-vapor mixture, an air-vapor outlet above the level of said impure water at the hot end thereof, and an impure water outlet below the level of said impure water at said hot end thereof communicating with said lower passage;
heating means at said hot end of said outer chamber including an air-vapor inlet communicating with said air-vapor outlet of said upper passage and an outlet to said outer chamber, said heating means increasing the temperature of said air-vapor mixture whereby said heated air-vapor mixture upon entering said outer chamber transfers heat to the outer wall of said thermally conductive inner chamber thereby cooling and condensing fresh water which collects in the bottom of said outer chamber:
exhaust means in said outer chamber proximate said cool end for exhausting to outside ambient thereby inducing flow through said upper passage, said heater, and said outer chamber;
said outer chamber including an outlet for said fresh water at said cool end, and said lower passage of said inner chamber including an outlet at said cool end for discharging the portion of said impure water not evaporated.

10. The desalination apparatus of claim 9 wherein said impure water evaporates and subsequently condenses as fresh water in said outer chamber at a temperature below the boiling point of water, said apparatus remaining at ambient atmospheric pressure throughout the desalination process.

11. The desalination apparatus of claim 9 wherein said apparatus is configured whereby said impure water and said portion of impure water not evaporated are circulated through said apparatus by the force of gravity.

12. The desalination apparatus of claim 9 wherein said exhaust means is connected to said air inlet to provide for recirculation of said air-vapor mixture within said apparatus, and said lower passage is vented to ambient to prevent pressure buildup resulting from dissolved gases released during evaporation of said impure water.

13. The desalination apparatus of claim 9 wherein said outer wall of said inner chamber includes corrugations to increase the heat transfer area thereby increasing the rate of condensation.

14. The desalination apparatus of claim 9 wherein a non-condensable gas other than ambient air is utilized.

15. The desalination apparatus of claim 9 wherein
said outer chamber includes three separate compartments, a first compartment encompassing said cool end, a second compartment at said hot end, and a third intermediate compartment encompassing a plurality of said inner chambers wherein said air-vapor is cooled thereby condensing fresh water;
said plurality of inner chambers positioned relative to each other to provide gravity flow of said impure inlet water and said portion of impure water not evaporated;
said inner chambers extend from said cool end compartment to said hot end compartment, said ambient air and impure water flow into said cool end compartment and thence into said upper passage of each of said inner chambers, and said air-vapor outlet of each said upper passage communicates with said hot end compartment; and
said cool end compartment includes a drain for exhausting said impure water not evaporated from said apparatus and said central compartment includes a drain proximate said cool end for exiting of said fresh water.

16. The desalination apparatus of claim 15 further including means for controlling the level of said impure water in the upper passage of each inner chamber by providing an excess of said impure water, assuring a proper supply for said inner chamber, and exhausting the excess to the cool end of said lower passage to exit through a properly located drain aperture; and
wherein said means for controlling the level of said impure water in each inner chamber includes a pair of venturis located and sized to produce identical signals when a predetermined ratio of impure water to fresh water is achieved, and a diaphragm-operated throttling valve located and configured to meter said impure water flow as required to obtain the desired ratio of impure water flow rate to fresh water flow rate when the signals of said venturis match.

17. The desalination apparatus of claim 15 further including
baffle means in said intermediate compartment for directing said air vapor mixture across said plurality of inner chambers in multiple passes from said hot end to said air-vapor exhaust means at said cool end;
each said inner chamber in said first compartment including trough means for maintaining the proper impure water level in each of said inner chamber's upper passage, said trough means configured for receiving said impure water into the trough of the uppermost inner chamber and filling to a desired level after which excess impure water is drained to the second uppermost trough, the process continuing until all trough means are filled to the desired level.

18. The desalination apparatus of claim 15 wherein said exhaust means is positioned between said first compartment and said central compartment whereby said air and air-vapor exhausts into said first compartment to thereby provide for recirculation of said air and air-vapor mixture within said apparatus.

19. Desalination apparatus for extracting fresh water from impure water comprising:
a thermally insulated counter-flow heat exchanger including an outer chamber substantially encompassing an inner chamber; said inner chamber composed of a thermally conductive material and including an upper passage and a lower passage, said heat exchanger having a cool end and a hot end;
said upper passage including an ambient air inlet and an impure water inlet at said cool end, an air-vapor outlet above the level of said impure water at said hot end; and an impure water outlet below the level of said impure water at said hot end communicating with said lower passage and exhausting at said cool end;
heating means proximate said hot end of said outer chamber including an air-vapor inlet communicating with said air-vapor outlet of said upper passage and an outlet to said outer chamber, said heating means increasing the temperature of said air-vapor mixture whereby said heated air-vapor mixture upon entering said outer chamber transfers heat to the outer wall of said thermally conductive inner chamber thereby cooling and condensing fresh water which collects in the bottom of said outer chamber:
exhaust means in said outer chamber proximate said cool end to induce air flow through said upper passage, said heater, and said outer chamber;
said outer chamber including an outlet for said fresh water; and
said impure water evaporates in said inner chamber and condenses in said outer chamber at a temperature below the boiling point of water, said apparatus remaining at ambient atmospheric pressure throughout the desalination process.

20. The desalination apparatus of claim 19 wherein
said outer chamber includes three separate compartments, a first compartment encompassing said cool end, a second compartment at said hot end, and a third intermediate compartment encompasses a plurality of said inner chambers wherein said air-vapor is cooled and its vapor condensed to said fresh water;
said inner chambers extend from said cool end compartment to said hot end compartment, said ambient air and impure water flows into said first compartment and thence into said upper passage of each of said inner chambers, and said air-vapor outlet of each said upper passage communicates with said hot end compartment and thence to said heating means;
said plurality of inner chambers positioned relative to each other to provide gravity flow of said impure water inlet and said portion of impure water not evaporated; and
said cool end compartment includes a drain for exhausting said impure water not evaporated from said apparatus, and said intermediate compartment includes a drain proximate said cool end for exiting of said fresh water.

21. The desalination apparatus of claim 20 further including
baffle means in said intermediate compartment for directing said air vapor mixture across said plurality of inner chambers in multiple passes from said hot end to said air-vapor exhaust means;
the portion of each said inner chamber extending into said cool end compartment including trough means for maintaining the proper impure water level in each of said inner chamber's upper passage, said trough means configured for receiving said impure water into the trough of the uppermost inner chamber and filling to a desired level after which excess impure water is drained to the second uppermost trough, the process continuing until all troughs are filled to a desired level.

22. The desalination apparatus of claim 21 further including means for controlling the supply of said impure water entering said cool end compartment including a pair of venturis located and sized to produce identical signals when a predetermined ratio of impure water to fresh water is achieved and a diaphragm-operated throttling valve located and configured to meter said impure water flow as required to obtain a desired ratio of impure water flow rate to fresh water flow rate when the signals of said venturis match.

23. A method of extracting fresh water from impure water, which method comprises passing air over said impure water in an evaporate region to form an air-vapor mixture, passing said air-vapor mixture through a heater to increase the temperature thereof, and passing the heated air-vapor into a condensate region wherein heat transfer to said evaporate region condenses fresh water in said condensate region.

24. A method according to claim 23, wherein said impure water evaporates and subsequently condenses in said condensate region at a temperature below the boiling point of water and at ambient atmospheric pressure.
